(19) United States
(12) Patent Application Publication
(10) Pub. No.: US 2019/0004392 A1
(43) Pub. Date: Jan. 3, 2019

(54) INFORMATION PROCESSING METHOD AND ELECTRONIC APPARATUS

(71) Applicant: LENOVO (BEIJING) CO., LTD., Beijing (CN)

(72) Inventor: Qicheng DING, Beijing (CN)

(21) Appl. No.: 16/023,845

(22) Filed: Jun. 29, 2018

(30) Foreign Application Priority Data
Jun. 29, 2017 (CN) 201710515233.9

(51) Int. Cl. G02F 1/29; G06T 7/50; A63F 13/26

(52) U.S. Cl. CPC G02F 1/29; G06T 7/50; A63F 2300/8082; G02F 2001/294; A63F 13/26

(57) ABSTRACT

An information processing method includes determining a type of a virtual scene displayed by a virtual electronic device, determining a target focus distance corresponding to the type of the virtual scene as determined, and configuring a refractive index of a lens of the virtual electronic device according to the target focus distance as determined.

### CROSS-REFERENCE TO RELATED APPLICATION

This application claims priority to Chinese Patent Application No. 201710515233.9, filed on Jun. 29, 2017, the entire contents of which are incorporated herein by reference.

### TECHNICAL FIELD

The present disclosure generally relates to the field of information processing technologies and, more particularly, to an information processing method and an information processing electronic apparatus.

### BACKGROUND

Virtual reality (VR) and augmented reality (AR) technologies can perform or enhance virtual scene display for objects and strengthen visual effect and sense for users.

A focus depth of the human eye may be different for different objects, which is referred to as “focus blur”. For example, when the eye is focused on a distant mountain, a ciliary muscle is relaxed, such that a long-range scene is clear and a close-range scene is blurred, and when the eye is focused on a close-range scene, the ciliary muscle is contracted, making the close-range scene clear.

However, conventional virtual reality devices are often headset display devices. Further, as shown in FIG. 1, in the virtual reality device, a distance between a display screen and the human eye is a fixed value. Thus, the user's left eye and right eye independently focus on a fixed distance plane and produce a “binocular disparity” based on the fixed distance.

When the depth information perceived through the “focus blur” is inconsistent with the depth information perceived through the “binocular disparity.” the brain may force the ciliary muscle to adjust to a new level of relaxation/contraction, so as to match with the depth information perceived through the “binocular disparity,” causing a conflict between focus and disparity, and a confused focus length. Thus, the human eye may observe a blurred image, resulting in dizziness, eye fatigue, and poor user experience.

### SUMMARY

In one aspect, the present disclosure provides an information processing method. The information processing method includes determining a type of a virtual scene displayed by a virtual electronic device, determining a target focus distance corresponding to the type of the virtual scene as determined, and configuring a refractive index of a lens of the virtual electronic device according to the target focus distance as determined.

Another aspect of the present disclosure provides an electronic apparatus including a lens, a display, and a processor. The display is configured to display a virtual scene including a display object. The processor is configured to determine a type of the virtual scene, determine a target focus distance corresponding to the type of the virtual scene as determined, and configure a refractive index of the lens of the electronic apparatus according to the target focus distance as determined.

### BRIEF DESCRIPTION OF THE FIGURES

The following drawings are merely examples for illustrative purposes according to various disclosed embodiments and are not intended to limit the scope of the present disclosure.

FIG. 1 illustrates a schematic view of a conflict between focus and disparity in a conventional virtual electronic device.

FIG. 2 illustrates a flow chart of an example of information processing method consistent with disclosed embodiments.

FIG. 3 illustrates a flow chart of an example of method for determining a target focus distance consistent with disclosed embodiments.

FIG. 4 illustrates a schematic diagram of comfortable binocular vergence distance intervals corresponding to different monocular focus distances.

FIG. 5 illustrates a schematic view of switching a lens refractive index and a focus distance in a virtual electronic device consistent with the disclosed embodiments.

FIG. 6 illustrates a block diagram of an example of electronic apparatus consistent with the disclosed embodiments.

FIG. 7 illustrates a block diagram of an example of internal structure of an example of electronic apparatus consistent with the disclosed embodiments.

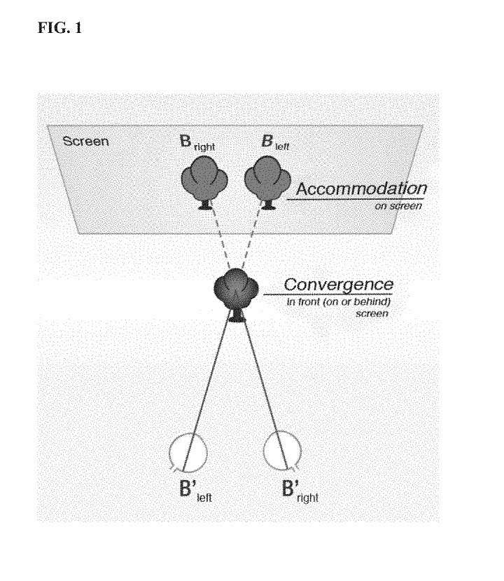

### DETAILED DESCRIPTION OF EMBODIMENTS

Embodiments of the disclosure will now be described in more detail with reference to the drawings. It is to be noted that, the embodiments are presented herein for purposes of illustration and description only, and are not intended to be exhaustive or to limit the scope of the present disclosure.

The aspects and features of the present disclosure can be understood by those skilled in the art through the embodiments of the present disclosure further described in detail with reference to the accompanying drawings.

The present disclosure provides an information processing method for applying to a virtual electronic device. The method may include obtaining a type of a virtual scene displayed by the virtual electronic device, determining a target focus distance corresponding to the type, and switching a refractive index of a lens of the virtual electronic device, such that a current focus distance of the virtual electronic device is equal to or close to the target focus distance. Accordingly, the technical solution can adjust the refractive index of the lens according to the type of the virtual scene, such that the current focus distance of the virtual electronic device may be equal to or close to a focus depth of an object in the current virtual scene. A conflict between focus blur and binocular disparity, also referred to as a “vergence-accommodation conflict,” may be suppressed, and thus dizziness may not occur, thereby improving user comfortability of wearing the virtual electronic device.

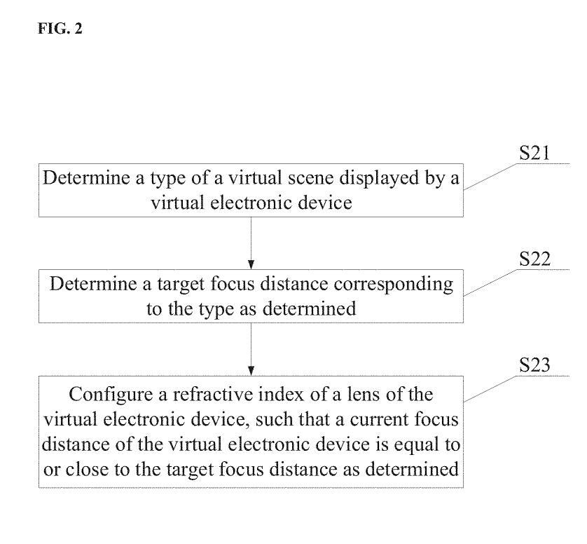

FIG. 2 illustrates a flow chart of an example of information processing method for a virtual electronic device consistent with the disclosure. With reference to FIG. 2, the method is described below.

At S21, a type of a virtual scene displayed by the virtual electronic device is determined.

In some embodiments, the virtual electronic device may include one of various types. For example, the virtual electronic device may include full immersion virtual reality (VR) device or an interactive augmented reality (AR) device. A VR device may separate the user's visual sense and auditory sense from the external environment, and may guide the user to have a feeling of being in a virtual environment. The display principle is to divide the content in separate screens, to form and display separate images for a left eye and a right eye by superimpositions through left and right lens, respectively. The human eyes may obtain information containing the difference and thus generate a three-dimensional sense in brain.

Usually, a virtual electronic device may display a virtual scene, such as a 3-dimensional (3D) movie, a game scene video, static text, e.g., letters, or another content. In the current process, the virtual scenes displayed by the virtual electronic device may be classified according to types of the virtual scenes. In some embodiments, the classification of the virtual scenes may be set based on experience, e.g., experience of a manufacturer. For example, according to the resource types of the virtual scenes often displayed by the virtual electronic device, the virtual scenes may be classified into a text type, a television type, a movie type, a game type, or another suitable scene type. In some other embodiments, the type classification may also be set by a user. For example, according to display dimensions of the virtual scenes, the virtual scenes may be classified into a 2-dimensional (2D) display virtual scene or a 3D display virtual scene.

Regardless of how the types of virtual scenes are classified, in some embodiments, the virtual electronic device may need to be provided in advance with a rule of virtual scene type classification, referred to as a classification rule. Correspondingly, obtaining the type of the virtual scene displayed by the virtual electronic device may include obtaining a content of the virtual scene currently displayed by the virtual electronic device, and searching in the classification rule to determine the type of the virtual scene.

For example, the virtual electronic device can classify virtual scenes into a text type, a television type, and a movie type, according to optimized display depths of the virtual scenes. If the virtual scene currently displayed by the virtual electronic device is obtained as a TV variety show, it may be determined that the type of the virtual scene is a television type.

In some embodiments, in the above-described process of determining the type of the virtual scene, the type of the virtual scene may be determined by, for example, configuring a same identifier for a same type of virtual scenes and determining the type of the current virtual scene by determining the identifier of the current virtual scene. For example, the identifier “a” may correspond to a text type, the identifier “b” may correspond to a television type, and the identifier “c” may correspond to a movie type. If the currently displayed virtual scene is obtained as a television variety show, and the identifier of the television variety show is the identifier “b”, it may be determined that the virtual scene currently displayed by the virtual electronic device is of a television type.

The above-described classification rules are merely for illustrative purposes and do not limit the scope of the present disclosure. In the present disclosure, classification rules may be selected according to various application scenarios.

At S22, a target focus distance corresponding to the type is determined.

As described above, the conflict between focus and disparity, i.e., the vergence-accommodation conflict, may occur in a conventional virtual electronic device. Consistent with the disclosure, according to the type of virtual scene, an optimized focus distance may be defined for the type of virtual scene. Further, a target focus distance can be determined according to the optimized focus distance. The target focus distance may be determined to be, for example, equal to or close to the optimized focus distance For example, an optimized focus distance corresponding to the text type may be approximately 0.5 m, i.e., 0.5 meters, an optimized focus distance corresponding to the television type may be approximately 5 m, an optimized focus distance corresponding to the movie type may be approximately 10 m, and an optimized focus distance corresponding to the game type may be from approximately 0.5 m to approximately 20 m.

In some embodiments, the optimized focus distance of the game type may be relatively unfixed, and may need to be determined according to contents displayed in the virtual scene of the game type. For example, in a war game, if a content of the currently displayed scene includes “enemy” information, e.g., a name, a gender, a height, a lethality, and/or another suitable parameter, it may be determined that the optimized focus distance of the current virtual scene is the same as the optimized focus distance of the text type, e.g., approximately 0.5 m. For example, if the content of the currently displayed scene is a dynamic scene display content, it may be determined that the optimized focus distance of the current virtual scene is the same as the optimized focus distance of the television type, e.g., approximately 5 m. For example, if the content of the currently displayed scene is a distant scene, such as an open mountain forest, it may be determined that the optimized focus distance of the current virtual scene is the same as the optimized focus distance of the movie type, e.g., approximately 10 m.

A target focus distance of the type may be obtained by, for example, searching in a correspondence table of the type of the virtual scene displayed in the virtual electronic device and the optimized focus distance.

At S23, a refractive index of a lens of the virtual electronic device is configured, such that a current focus distance of the virtual electronic device is equal to or close to the target focus distance.

In conventional virtual electronic devices, refractive indices of the left and right lenses are fixed before delivery. Thus, when the human eye views through the lenses, the focus distance may be fixed at a preset value. For example, if a monocular imaging position is fixed at approximately 1.3 m and a comfortable focus distance is at a different distance, eye fatigue may occur. For example, an optimized focus distance for reading text may be approximately 0.5 m, and if the focus distance of the virtual electronic device is set at approximately 1.3 m, the user may feel eye discomfort.

Thus, in some embodiments, lenses having a plurality of refractive indices may be provided in a virtual electronic device. For example, a combination of three or four lenses may be selected according to common types of the virtual scenes. For example, according to the types of the virtual scenes and based on one's experience, the virtual scenes may be classified into three types: a text type, a television type, and a movie type. The optimized focus distances corresponding to the three types may be, for example, approximately 0.5 m, approximately 5 m, and approximately 10 m, respectively. The refractive index of each lens may be determined according to, for example, the optimized focus distance and a distance between the human eye and the lens.

When the type of the virtual scene changes, a lens having a refractive index corresponding to the type may be selected, such that the human eye may obtain, through the lens, a focus distance that is same as or equal to an optimized focus distance. Further, the optimized focus distance may serve as a depth perceived through a binocular disparity, i.e., a binocular parallax. Thus, the depth perceived through a binocular disparity or a binocular parallax may be the same as or close to a depth, i.e., depth information, perceived by the human eye through “focus blur.” Thus, a level of contraction or relaxation of a ciliary muscle of the human eye may match with the depth information provided by the binocular disparity, the human eye may stay at a status of natural viewing, and the eyes may feel more comfortable.

In the information processing method of the disclosure, the refractive index of the lens may be adjusted according to the type of the virtual scene, such that the current focus distance may be equal to or close to the focus depth of an object in the current virtual scene, thereby suppressing a conflict between the “focus blur” and the binocular disparity. As a result, dizziness may not occur, and the user's comfortability of wearing the virtual electronic device can be improved.

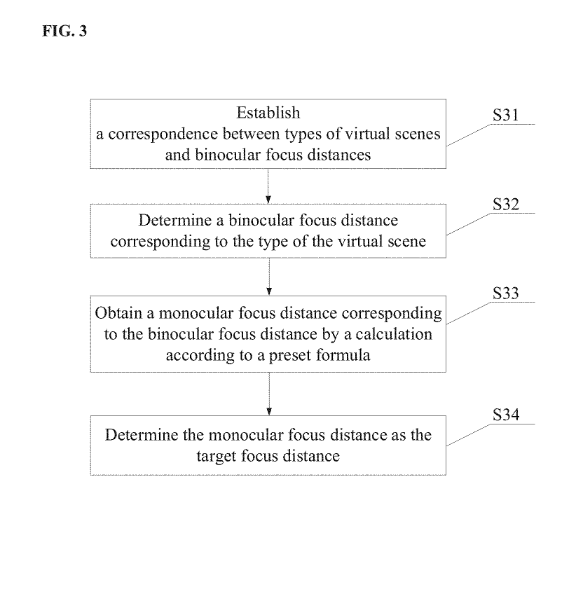

Further, the present disclosure also provides a method for determining the target focus distance. With reference to FIG. 3, the method is described below.

At S31, a correspondence between types of virtual scenes and binocular focus distances, i.e., binocular vergence distances, is established.

Correspondingly, the process S22 may determine the target focus distance corresponding to the type, as follows.

At S32, a binocular focus distance corresponding to the type of the virtual scene is determined.

At S33, a monocular focus distance corresponding to the binocular focus distance is obtained by a calculation according to a preset formula.

At S34, the monocular focus distance is determined as the target focus distance.

In the embodiments of the disclosure, according to the types of the virtual scenes, the virtual scenes may be, for example, classified into three types: the text type, the television type, and the movie type, based on one's experience. The optimized focus distances corresponding to the three types may be approximately 0.5 in, 5 m, and 10 m, respectively. The optimized focus distance may be a vergence distance of the two eyes, i.e., a binocular vergence distance, and in the virtual electronic device, a vergence distance of each of the left and right eyes may need to be determined according to the vergence distance of the two eyes.

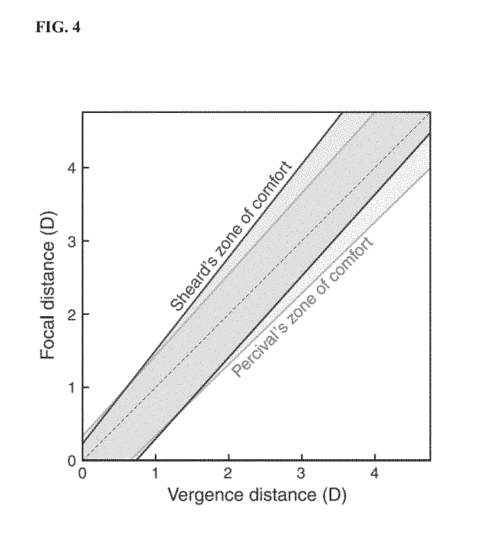

FIG. 4 illustrates a schematic diagram of comfortable binocular vergence distance intervals corresponding to different monocular focus distances, obtained by a plurality of display-comfort experiments on a virtual electronic device. In FIG. 4, the horizontal axis is a reciprocal of the binocular vergence distance and the vertical axis is a reciprocal of the monocular focus distance. In some embodiments, for example, an optimized focus distance may be set to be in a range from approximately 0.75 m to approximately 3.5 m. Further, the target focus distance corresponding to the type of the virtual scene may be determined, in conjunction with, e.g., one's experience.

In some embodiments, a correspondence between the monocular focus distance and the refractive index of the lens may be established in advance. A refractive index of lens corresponding to the monocular focus distance may be obtained as a target refractive index. A lens having the target refractive index may be used as a current lens of the virtual electronic device.

As a lens may have only one refractive index, in some embodiments, the virtual electronic device may need to include a plurality of lenses, and the refractive indices of the plurality of lenses may be different. In some other embodiments, a lens having a fixed refractive index may be provided in the virtual electronic device. When the refractive index of the lens needs to be configured, such as needing to be changed, transparent films having different refractive indices may be provided on the lens to configure, e.g., to change, the refractive index of the lens.

In the present disclosure, a lens may include one or more sub-lenses. That is, one or more sub-lenses may be considered as in a same group, and together referred to as “a lens.”

In above-described embodiments, the monocular focus distance may be determined according to the binocular focus distance, and further a refractive index of the lens to switch to may be obtained. In some other embodiments, the monocular focus distance may be directly determined for the type of the virtual scene currently displayed by the virtual electronic device. For example, when the virtual scene is of a variation type, i.e., a type having a frequently-varied scene such as the game type, the virtual scene, e.g., a game scene, may vary frequently during a display. For this type of virtual scene, the monocular focus distance may be determined according to a type of a display object in the virtual scene, and further, the monocular focus distance corresponding to the type of the display object may be determined as the target focus distance.

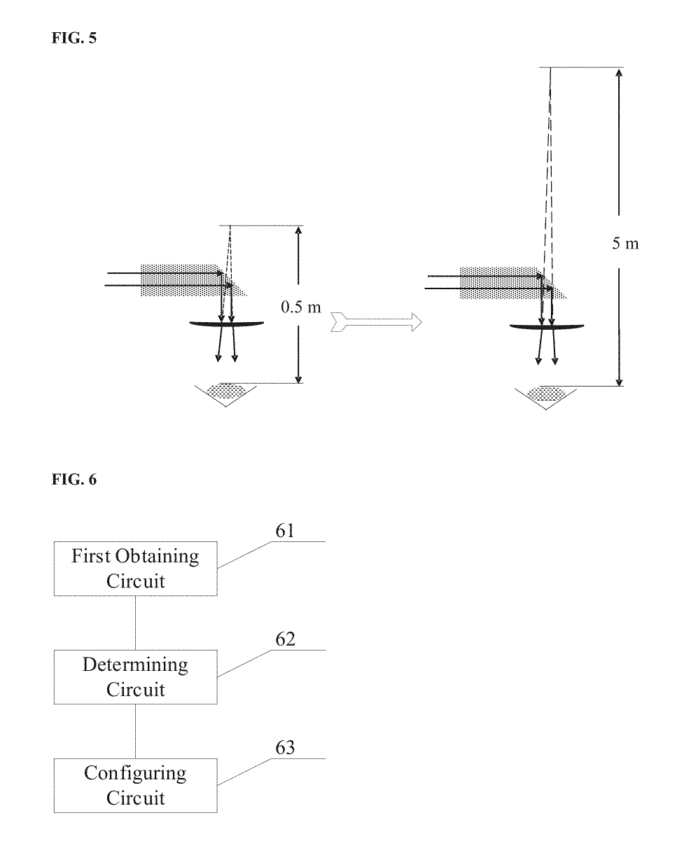

For example, as shown in FIG. 5, the type of the virtual scene displayed on the virtual electronic device may be obtained. If the current virtual scene is an article reading scene, it may be determined that the virtual scene is of the text type, and further the optimized focus distance may be determined as approximately 0.5 m. The optimized focus distance of approximately 0.5 m that serves as a vergence distance may be used in conjunction with the curve in FIG. 4 to determine the monocular focus distance, and further, the refractive index may be determined according to the monocular focus distance. Further, it may be checked whether the refractive index of the current lens is equal to or close to the refractive index determined in the above-described processes. If not, the current lens used in the virtual electronic device may be changed to a lens having the refractive index determined according to the monocular focus distance.

In response to a change of the virtual scene of the virtual electronic device, the above processes may be repeated to determine the refractive index conforming to the type of the current virtual scene and to change the lens. If the current virtual scene is a virtual scene of a television program, the type of the virtual scene may be determined as the television type, and the optimized focus distance may be determined as approximately 5 m. The optimized focus distance of approximately 5 m that serves as a vergence distance may be used in conjunction with the curve in FIG. 4 to determine the monocular focus distance. Further, the refractive index may be determined according to the monocular focus distance. Further, it may be checked whether the refractive index of the current lens is the same as or close to the refractive index determined in the above-described processes. If not, the current lens used by the virtual electronic device may be changed to a lens having the refractive index determined according to the monocular focus distance. Correspondingly, as shown in FIG. 5, the refractive index of the lens is configured by changing from a close-range refraction lens to a long-range refraction lens.

The above-described embodiments provide the method of configuring the lens according to the lens refractive index obtained by calculation. In some other embodiments, the refractive index of the lens may be configured according to a configuring instruction, e.g., a changing instruction or a switching instruction, from the user. For example, a changing button may be provided on the virtual electronic device, and when the user triggers the button, lenses of different refractive indices may be sequentially switched to improve human eye viewing experience.

The method may include obtaining a changing instruction, i.e., a focus distance changing instruction, based on the virtual electronic device from the user, where the focus distance changing instruction characterizes the refractive index of the lens to switch to; and switching a lens having the refractive index corresponding to the changing instruction to be a current lens of the virtual electronic device.

Further, in some embodiments, a distance between the lens and the eye may be fine adjusted to further adjust an actual focus distance after the refractive index of the lens is configured, e.g., changed.

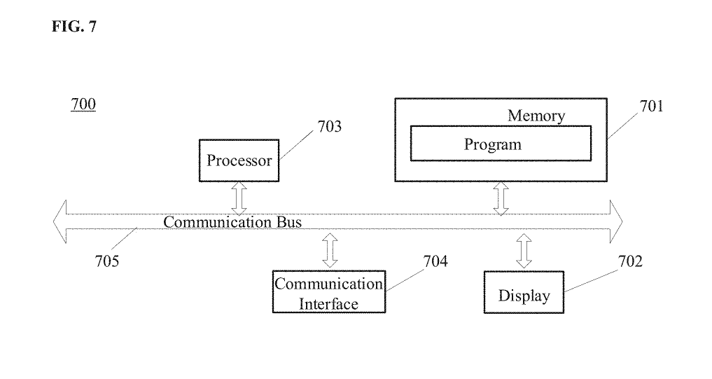

The methods described in the above-described embodiments may be implemented by electronic apparatuses in various forms. The disclosure further provides an electronic apparatus corresponding to the information processing method, for a virtual electronic device. FIG. 6 illustrates a block diagram of an example of electronic apparatus consistent with the disclosure. The electronic apparatus includes a first obtaining circuit 61, a determining circuit 62, and a configuring circuit 63.

The first obtaining circuit 61 is configured to determine a type of a virtual scene displayed by the virtual electronic device.

The determining circuit 62 is configured to determine a target focus distance corresponding to the type.

The configuring circuit 63 is configured to configure a refractive index of a lens of the virtual electronic device, such that a current focus distance of the virtual electronic device is equal to or close to the target focus distance.

In some embodiments, the electronic apparatus may further include a first creating circuit. The first creating circuit may be configured to establish in advance a correspondence between the type of the virtual scene and a binocular focus distance.

Correspondingly, the determining circuit 62 may include a first determining sub-circuit, a calculating sub-circuit, and a second determining sub-circuit. The first determining sub-circuit may be configured to determine the binocular focus distance corresponding to the type of the virtual scene. The calculating sub-circuit may be configured to obtain a monocular focus distance corresponding to the binocular focus distance by a calculation according to a preset formula. The second determining sub-circuit may be configured to determine the target focus distance according to the monocular focus distance, i.e., to use the monocular focus distance as the target focus distance.

In some embodiments, the electronic apparatus may further include a second obtaining circuit. The second creating circuit may be configured to establish in advance a correspondence between monocular focus distances and refractive indices of lenses.

Correspondingly, the configuring circuit 63 may include a first obtaining sub-circuit and a changing sub-circuit. The first obtaining sub-circuit may be configured to obtain a refractive index of a lens corresponding to the monocular focus distance to use as a target refractive index. The changing sub-circuit may be configured to switch a lens having the target refractive index to be a current lens of the virtual electronic device.

In some embodiments, when the virtual scene displayed by the virtual electronic device is of the variation type, the determining circuit 62 may include a second obtaining sub-circuit and a third determining sub-circuit. The second obtaining sub-circuit may be configured to obtain a type of a display object in the virtual scene. The third determining sub-circuit may be configured to determine the target focus distance according to the monocular focus distance corresponding to the type of the display object, i.e., to use the monocular focus distance corresponding to the type of the display object as the target focus distance.

In some embodiments, the electronic apparatus may further include a second obtaining circuit and a changing circuit. The second obtaining circuit may be configured to obtain a focus distance changing instruction based on the virtual electronic device from a user. The focus distance changing instruction may characterize the refractive index of the lens to switch to. For example, the focus distance changing instruction may contain information about the refractive index of the lens to switch to.

The changing circuit may be configured to switch a lens having the refractive index corresponding to the changing instruction to be a current lens of the virtual electronic device.

The operating principle can be referenced to the above-described method embodiments, the descriptions of which are not repeated here.

The embodiments of the disclosure also provide an internal structure, e.g., a hardware structure, of an electronic apparatus. FIG. 7 illustrates a block diagram of an example of internal structure, e.g., hardware structure, of an electronic apparatus 700 consistent with the disclosure. The electronic apparatus 700 can include or be part of a virtual electronic device consistent with the disclosure. As shown in FIG. 7, the electronic apparatus 700 includes a memory 701, a display 702, and a possessor 703.

The memory 701 is configured to store one or more programs.

The one or more programs may include a program code, and the program code may include computer operation instructions.

The memory 701 may include at least one of a high-speed random-access memory (RAM) or a non-volatile memory, such as at least one magnetic disk storage.

The display 702 is configured to display a virtual scene including a display object.

The processor 703 is configured to execute the one or more programs to determine a type of the virtual scene displayed by the virtual electronic device; to determine a target focus distance corresponding to the type as determined; and to configure a refractive index of lens of the virtual electronic device, such that a current focus distance of the virtual electronic device is equal to or close to the target focus distance.

The processor 703 may be, for example, a central processing unit (CPU), an application specific integrated circuit (ASIC), or one or more integrated circuits configured to implement the embodiments of the present disclosure.

In some embodiments, as shown in FIG. 7, the electronic apparatus 700 also includes a communication interface 704 and a communication bus 705. The memory 701, the display 702, the processor 703, and the communication interface 704 may communicate with each other through the communication bus 705.

In addition, the processor may also be configured to establish in advance a correspondence between types of virtual scenes and binocular focus distances.

Correspondingly, the processor may be configured to determine the target focus distance corresponding to the type by determining a binocular focus distance corresponding to the type of the virtual scene, obtaining a monocular focus distance corresponding to the binocular focus distance by a calculation according to a preset formula, and determining the monocular focus distance as the target focus distance, i.e., determining the target focus distance according to the monocular focus distance.

Further, the processor may also be configured to establish in advance a correspondence between monocular focus distances and refractive indices of lenses. Correspondingly, the processor may be configured to change the refractive index of the lens of the virtual electronic device by obtaining a refractive index of lens corresponding to the monocular focus distance as the target refractive index and switching a lens having the target refractive index to be the current lens of the virtual electronic device, such that the current focus distance of the virtual electronic device is equal to or close to the target focus distance.

If the virtual scene displayed by the virtual electronic device is of the variation type, the processor may be configured to determine the target focus distance corresponding to the type by obtaining a type of a display object in the virtual scene and determining a monocular focus distance corresponding to the type of the display object as the target focus distance.

In addition, the processor may be also configured to obtain a focus distance changing instruction based on the virtual electronic device from a user, where the focus distance changing instruction characterizes a refractive index of a lens to switch to; and to switch a lens having the refractive index corresponding to the changing instruction to be a current lens of the virtual electronic device.

The present disclosure provides an information processing method for applying to a virtual electronic device. The method may include obtaining a type of a virtual scene displayed by the virtual electronic device, determining a target focus distance corresponding to the type, and changing the refractive index of a lens of the virtual electronic device, such that a current focus distance of the virtual electronic device is equal to or close to the target focus distance. Accordingly, consistent with the disclosure, the refractive index of the lens can be adjusted according to the type of the virtual scene, such that different current focus distances may set to be equal to or close to focus depths of different objects in current virtual scenes. A conflict between focus blur and binocular disparity may be suppressed. Thus dizziness may not occur, and user comfortability of wearing the virtual electronic device may be improved.

The present disclosure provides an information processing method and an information processing electronic apparatus. The information processing method may be applied to a virtual electronic device. The information processing method may include determining a type of a virtual scene displayed by the virtual electronic device, determining a target focus distance corresponding to the type as determined, and configuring a refractive index of a lens of the virtual electronic device, such that a current focus distance of the virtual electronic device is equal to or close to the target focus distance. Accordingly, consistent with the disclosure, the refractive index of the lens can be adjusted according to the type of the virtual scene, or when the type of the virtual scene changes, a lens having the refractive index corresponding to the type can be selected, such that different current focus distances may be set to be equal to or close to focus depths of objects in current virtual scenes. By making depth information perceived through the “binocular disparity” the same as or close to depth information perceived through “focus blur” of the human eye, a conflict between the focus blur and the binocular disparity may be suppressed. Thus dizziness may not occur, and user comfortability of wearing the virtual electronic device may be improved.

The embodiments of the present disclosure are described in a progressive manner, which may be focused on differences with respect to other embodiments. The same or similar portions of the various embodiments may be referenced to each other. Because devices provided in the embodiments correspond to methods provided in the embodiments, the descriptions about the devices are relatively simple. References can be made to descriptions of method embodiments for the relevant portions of devices.

The foregoing description of the embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to persons skilled in this art. The embodiments are chosen and described in order to explain the principles of the technology, with various modifications suitable to the particular use or implementation contemplated. It is intended that the scope of the invention be defined by the claims appended hereto in which all terms are meant in their broadest reasonable sense unless otherwise indicated. Therefore, the term “the disclosure,” “the present disclosure,” or the like does not necessarily limit the claim scope to a specific embodiment, and the reference to exemplary embodiments of the disclosure does not imply a limitation on the invention, and no such limitation is to be inferred. Moreover, the claims may refer to “first,” “second,” etc., followed by a noun or element. Such terms should be understood as a nomenclature and should not be construed as giving the limitation on the number of the elements modified by such nomenclature unless specific number has been given. Any advantages and benefits described may or may not apply to all embodiments of the disclosure. It should be appreciated that variations may be made to the embodiments described by persons skilled in the art without departing from the scope of the present disclosure. Moreover, no element or component in the present disclosure is intended to be dedicated to the public regardless of whether the element or component is explicitly recited in the following claims.

What is claimed is:

1. An information processing method comprising:
determining a type of a virtual scene displayed by a virtual electronic device;
determining a target focus distance corresponding to the type of the virtual scene as determined; and
configuring a refractive index of a lens of the virtual electronic device according to the target focus distance as determined.

2. The method according to claim 1, wherein the determining the target focus distance includes:
determining a binocular focus distance based on the type of the virtual scene as determined;
obtaining a monocular focus distance based on the binocular focus distance; and determining the monocular focus distance as the target focus distance.

3. The method according to claim 2, wherein the configuring the refractive index of the lens of the virtual electronic device includes:
obtaining a target refractive index based on the monocular focus distance; and
configuring the lens of the virtual electronic device to the target refractive index.

4. The method according to claim 2, wherein determining the binocular focus distance includes any one of the steps comprising:
determining the binocular focus distance to be approximately 0.5 m in response to the type of the virtual scene being a text type;
determining the binocular focus distance to be approximately 5 m in response to the type of the virtual scene being a television type;
determining the binocular focus distance to be approximately 10 m in response to the type of the virtual scene being a movie type; and
determining the binocular focus distance to be from approximately 0.5 m to approximately 20 m in response to the type of the virtual scene being a game type.

5. The method according to claim 1, wherein:
the type of the virtual scene varies, and
determining the target focus distance includes:
determining a type of a display object in the virtual scene;
determining a monocular focus distance according to the type of the display object as determined; and
configuring the refractive index of the lens of the virtual electronic device to the monocular focus distance.

6. The method according to claim 5, wherein the type of the virtual scene is a game type.

7. The method according to claim 1, further comprising:
obtaining a focus distance changing instruction from a user, the focus distance changing instruction including information of a target refractive index; and
configuring the refractive index of the lens of the virtual electronic device to the target refractive index.

8. The method according to claim 1, wherein the configuring the refractive index of the lens of the virtual electronic device causes a focus distance of the virtual electronic device to be equal to or close to the target focus distance.

9. An electronic apparatus, comprising:
a lens;
a display configured to display a virtual scene including a display object; and
a processor configured to:
determine a type of the virtual scene;
determine a target focus distance corresponding to the type of the virtual scene as determined; and
configure a refractive index of the lens of the electronic apparatus according to the target focus distance as determined.

10. The electronic apparatus according to claim 9, wherein the processor is further configured to:
determine a binocular focus distance based on the type of the virtual scene as determined;
obtain a monocular focus distance based on the binocular focus distance; and
determine the monocular focus distance as the target focus distance.

11. The electronic apparatus according to claim 10, wherein the processor is further configured to:
obtain a target refractive index based on the monocular focus distance; and
configure the lens to the target refractive index.

12. The electronic apparatus according to claim 10, wherein the processor is further configured to perform any one of the functions comprising:
determine the binocular focus distance to be approximately 0.5 m in response to the type of the virtual scene being a text type;
determine the binocular focus distance to be approximately 5 m in response to the type of the virtual scene being a television type;
determine the binocular focus distance to be approximately 10 m in response to the type of the virtual scene being a movie type; and
determine the binocular focus distance to be from approximately 0.5 m to approximately 20 m in response to the type of the virtual scene being a game type.

13. The electronic apparatus according to claim 9, wherein:
the type of the virtual scene varies, and
the processor is further configured to:
determine a type of the display object in the virtual scene;
determine a monocular focus distance according to the type of the display object as determined; and
configure the refractive index of the lens to the monocular focus distance.

14. The electronic apparatus according to claim 13, wherein the type of the virtual scene is a game type.

15. The electronic apparatus according to claim 9, wherein the processor is further configured to:
obtain a focus distance changing instruction from a user, the focus distance changing instruction including information of a target refractive index; and
set the refractive index of the lens to the target refractive index.

16. The electronic apparatus according to claim 9, wherein a focus distance of the electronic apparatus with the refractive index as configured, is equal to or close to the target focus distance.
